(19) United States
(12) Patent Application Publication
(10) Pub. No.: US 2004/0094959 A1
(43) Pub. Date: May 20, 2004

(54) Device for coupling two conduits

(76) Inventor: Sami Shemtov, Aventura, FL (US)

Correspondence Address: HOWARD C. MISKIN, C/O STOLL, MISKIN, & BADIE, THE EMPIRE STATE BUILDING, 350 FIFTH AVENUE SUITE 4710, NEW YORK, NY, 10118, US

(21) Appl. No.: 10/299,408

(22) Filed: Nov. 19, 2002

(51) Int. Cl. F16L 27/00

(52) U.S. Cl. 285/354; 285/272

(57) ABSTRACT

A coupling device for a pair of wire carrying conduits that allows one of the conduits to swivel and pivot axially relative to the device and provides a liquid seal between the conduits. The coupling device includes a front tubular casing, a rear tubular casing and a lock nut interconnecting the front and rear tubular casings. The lock nut grips the corresponding first ends of the front and rear tubular casings and move the first ends into sealing relation. The lock nut holds the front and rear tubular casings in loose assembly such that the rear casing is pivotable and swivelable to the longitudinal axis while in the loose assembly to facilitate interconnection of two non axially aligning conduits.

### FIELD OF THE INVENTION

The invention relates to a device for coupling two conduits containing electrical cables and/or wires. In particular, an improved device that facilitates quicker coupling of a pair of conduits, provides a seal between the conduits and allows one of the conduits to swivel and pivot relative to the device.

### BACKGROUND OF THE INVENTION

Coupling devices are used to connect two or more conduits containing electrical cables and/or wires. A prior art coupling device for a pair of conduits is generally tubular, with threaded opposite ends for receiving the conduit. Such a prior art coupling device can only couple a pair of conduits end to end that are substantially coaxial, or it necessitates the complete disassembly of the coupling device and at least one of the conduits. For a pair of conduits that are angled relative to each other, besides requiring total disassembly of the coupling device and then reassembly the coupling device with the conduit and cables, such a prior art coupling device imparts undue stress on the coupling device and the conduits and may affect the performance of the coupling device, including any seal required. It is very difficult, if not impossible, in certain instances to properly and quickly, couple in a rain-tight connection two non-coaxially aligned conduits.

Therefore, there is a need for a coupling device that facilitates coupling a pair of conduits that are not necessarily coaxially aligned and provides a seal between the conduits.

### SUMMARY OF THE INVENTION

The present invention provides a coupling device for a pair of conduits that allows one of the conduits to swivel and pivot axially relative to the device and provides a liquid seal between the conduits.

The coupling device of the present invention comprises three main elements: a front tubular casing, a rear tubular casing and a lock nut interconnecting the front and rear tubular casings. The lock nut is internally threaded and has a tapered inwardly extending rib. Each of the two tubular casings has an outwardly extending rib at their first end, which is internally threaded to receive a conduit. The outer circumferential surface of the rib of the front tubular casing is threaded to threadedly receive the lock nut. A circular groove on the first end of the front tubular casing receives an o-ring.

As a coupling device, the rear tubular casing is placed through the lock nut, with the outwardly extending rib of the rear tubular casing sitting adjacent the inwardly extending rib of the lock nut and the second end of the rear tubular casing axially extending beyond the lock nut for receiving a conduit and cable. As the lock nut is tightened, the first end of the front tubular casing with the externally threaded rib matingly engages the internal thread of the lock nut.

The first ends of the front and rear tubular casings abut each other with the o-ring sealing the front and rear tubular casings to provide a rain tight seal to the two coupled conduits attached to the second ends of the front and rear tubular casings. When the lock nut is loosened on the two tubular casings, the lack of external threading on the circumferential surface of the rib of the rear tubular casing and the tapered inwardly extending rib of the locknut allow the rear tubular casing to swivel and pivot relative to the axis of the device to quickly and adaptively receive conduits at a non-axially aligning angle.

### BRIEF DESCRIPTION OF THE DRAWINGS

A preferred embodiment of the present invention has been chosen for purposes of illustration and description and is shown in the accompanying drawings forming a part of the specification wherein:

FIG. 1 is a cross sectional view of the loosely assembled coupling device of the present invention.

FIG. 2 is a cross sectional view of the front tubular casing of the present invention.

FIG. 3 is one end view of the front tubular casing taken from line 3-3 of FIG. 2.

FIG. 4 is the opposite end view of the front tubular casing taken from line 4-4 of FIG. 2.

FIG. 5 is a cross section view of rear tubular casing of the present invention.

FIG. 6 is one end view of the rear tubular casing taken from line 6-6 of FIG. 5.

FIG. 7 is a cross section view of the lock nut of the present invention.

FIG. 8 is one end view of the lock nut taken from line 8-8 of FIG. 7.

### DETAILED DESCRIPTION OF THE PREFERRED EMBODIMENTS

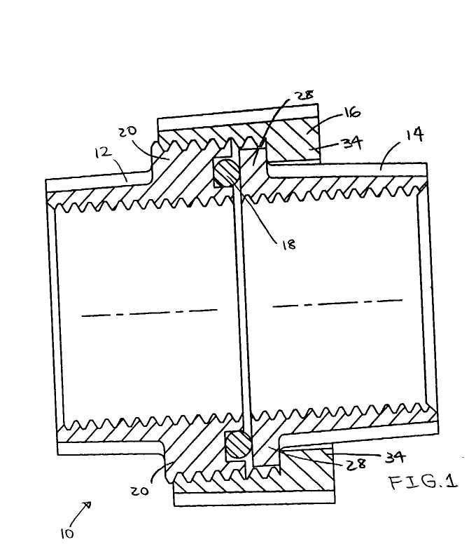

With reference to the drawings, wherein the same reference number indicates the same element throughout, there is shown in FIG. 1 a cross sectional view of the coupling device 10 of the present invention. As shown in FIG. 1, the coupling device 10 includes a front tubular casing 12, a rear tubular casing 14, a lock nut 16 interconnecting the front and rear tubular casings 12 and 14 and an o-ring 18 for sealing the connection between the front and rear tubular casings 12 and 14.

As shown in FIGS. 2, 3 and 4, the front tubular casing 12 has an outwardly extending rib 20 at the first end 22. The front casing 12 is internally threaded to receive a first conduit carrying electrical cables and/or wires on the opposite end. The outer circumferential surface of the rib 20 is threaded to receive the lock nut 16 (as shown in FIG. 1). A circular groove 24 on the first end of the front tubular casing 12 is adapted to receive the o-ring 18 (as shown in FIG. 1). On the outer circumferential surface of the front tubular casing 12 are a plurality of tabs 26 that facilitate handling of the front tubular casing 12 and axial rotation of the front tubular casing 12 with respect to the lock nut 16 and the first conduit received therein (not shown).

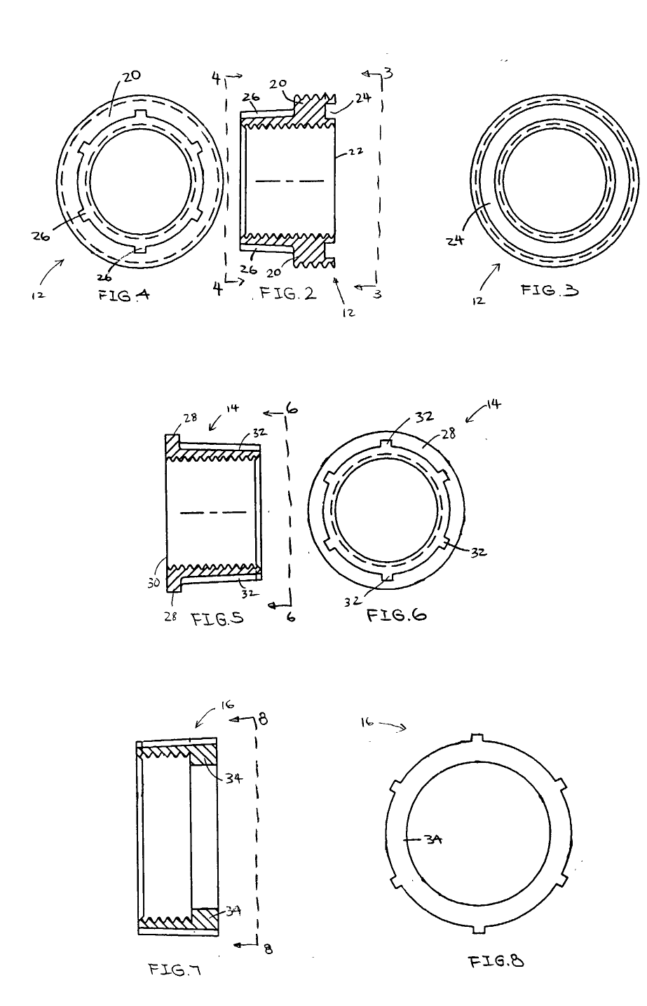

As shown in FIGS. 5 and 6, the rear tubular casing 14 has an outwardly extending rib 28 at the first end 30. The rear tubular casing 14 is internally threaded to receive a second conduit carrying electrical cables and/or wires on the opposite end. Compare to the front tubular casing 12, the outer circumferential surface of the rib 28 of the rear tubular casing 14 is not threaded. On the outer circumferential surface of the rear tubular casing 14 are a plurality of tabs 32 that facilitate handling of the rear tubular casing 14 and axial rotation of the rear tubular casing 14 with respect to the second conduit received therein (not shown).

As shown in FIGS. 7 and 8, the lock nut 16 is internally threaded and has a tapered inwardly extending rib 34.

As an assembled coupling device 10 of the present invention, the rear casing 14 is placed through the locknut 16, with the outwardly extending rib 28 of the rear tubular casing 14 sitting adjacent the inwardly extending rib 34 of the locknut 16 and the opposite end of the rear tubular casing 14 axially extending beyond the lock nut 16 for receiving the second conduit (not shown). As the lock nut 16 is tightened, the first end 22 of the front casing 12 with the externally threaded rib 20 matingly engages the internal thread of the lock nut 16. The first ends 22 and 30 of the front and rear casings 12 and 14 abut, respectively, each other with the o-ring 18 sealing the front and rear tubular casings 12 and 14 to provide a rain tight seal to the two coupled conduits (not shown) attached to the opposite or second ends of the front and rear tubular casings 12 and 14. The lack of external threading on the circumferential surface of the rib 28 of the rear tubular casing 14 and the tapered inwardly extending rib 34 of the lock nut 16 allow the rear tubular casing 14 to swivel and pivot relative to the axis of the coupling device 10 to quickly and adaptively receive conduits at a non-axially aligning angle. The outer circumferential surface of the rear tubular casing 14 may also be slightly tapered to provide additional space to swivel and pivot the rear tubular casing 14 relative to axis of the coupling device 10.

The features of the invention illustrated and described herein is the preferred embodiment. Therefore, it is understood that the appended claims are intended to cover unforeseeable embodiments with insubstantial differences that are within the spirit of the claims.

What I claim is:

1. A device for rain tight coupling of first and second wire carrying conduits, comprising:
a front tubular casing having a first end with a fastening means;
a rear tubular casing having a first end with an outwardly extending rib; and
adjustable locking means for interconnecting said first ends of said front and rear tubular casings, said locking means adapted to fixedly grip the corresponding first ends of said front and rear tubular casings and move said first ends into sealing relation, said locking means adapted to hold said front and rear tubular casings in loose assembly, said rear tubular casing being pivotable and swivelable relative to the longitudinal axis while in said loose assembly of said front and rear tubular casings.

2. The device of claim 1 wherein said fastening means comprises external threading on the circumferential surface of said first end of said front tubular casing.

3. The device of claim 1 wherein said fastening means comprises an outwardly extending rib at said first end of said front tubular casing and external threading on the circumferential surface of said outwardly extending rim.

4. The device of claim 1 wherein said front and rear tubular casings are internally threaded for receiving said first and second wire carrying conduits.

5. The device of claim 2 wherein said adjustable locking means comprises a lock nut having a tubular body with internal threading that matingly engages said external threading of said front tubular casing.

6. The device of claim 1 wherein said first end of said front tubular casing having sealing means for said first ends of said front and rear tubular casings.

7. The device of claim 6 wherein said sealing means comprises a circular groove on said first end of said front tubular casing and an o-ring receives in said circular groove.

8. The device of claim 1 wherein said adjustable locking means comprises a lock nut having a tubular body with a first end having an inwardly extending rib, said rear tubular casing being positioned axially through said lock nut with said rib of said rear tubular casing adjacent said inwardly extending rib of said lock nut.

9. The device of claim 1 wherein said front tubular casing having a second end adapted to receive said first wire carrying conduit and said rear tubular casing having a second end adapted to receive said second wire carrying conduit.

10. The device of claim 1 wherein said front tubular casing having a plurality of tabs on the circumferential surface of said front tubular casing to facilitate handling and axial rotation of said front tubular casing.

11. The device of claim 1 wherein said rear tubular casing having a plurality of tabs on the circumferential surface of said rear tubular casing to facilitate handling and axial rotation of said rear tubular casing.

12. The device of claim 8 wherein said tubular body of said lock nut having a plurality of tabs on the circumferential surface of said tubular body of said lock nut to facilitate handling and axial rotation of said lock nut.

13. The device of claim 8 wherein said inwardly extending rib of said lock nut is tapered to provide additional space for pivoting and swiveling said rear tubular casing.

14. The device of claim 9 wherein said rear tubular casing is tapered from said second end of said rear tubular casing to said first end of said rear tubular casing to provide additional space for pivoting and swiveling said rear tubular casing.
